(19) United States
(12) Patent Application Publication
(10) Pub. No.: US 2025/0071762 A1
(43) Pub. Date: Feb. 27, 2025

(54) METHOD FOR RESOURCE INDICATION

(71) Applicant: ZTE Corporation, Shenzhen (CN)

(72) Inventors: Jiajun XU, Shenzhen (CN); Hong TANG, Shenzhen (CN); Bo DAI, Shenzhen (CN); Mengzhu CHEN, Shenzhen (CN); Jun XU, Shenzhen (CN); Jianqiang DAI, Shenzhen (CN); Xiaoying MA, Shenzhen (CN)

(21) Appl. No.: 18/922,060

(22) Filed: Oct. 21, 2024

Related U.S. Application Data
(63) Continuation of application No. PCT/CN2022/088202, filed on Apr. 21, 2022.

(51) Int. Cl. H04W 72/20

(52) U.S. Cl. CPC H04W 72/20

(57) ABSTRACT

Method, device and computer program product for wireless communication are provided. A method includes: receiving, by a wireless communication terminal from a wireless communication node, first control signaling; determining, by the wireless communication terminal, one or more scheduled resources according to the first control signaling; and performing, by the wireless communication terminal, a transmission of uplink data or a reception of downlink data via the one or more scheduled resources.

### CROSS-REFERENCE TO RELATED APPLICATIONS

This application is a continuation of International Patent Application No. PCT/CN2022/088202, filed on Apr. 21, 2022, the disclosure of which is incorporated herein by reference in its entirety.

### TECHNICAL FIELD

This document is directed generally to wireless communications, in particular to 5^{th} generation (5G) or 6^{th} generation (6G) wireless communications.

### BACKGROUND

In beyond 5G and 6G communication, one of the promising services is characterized by quasi-periodicity, large and various data amount and stringent latency requirement, including e.g., extended reality (XR) service. In some approaches, granted transmission, including configured grant (CG) and semi-persistent scheduling (SPS), is capable of conveying periodic data by preconfigured resource without grant request and excessive power consumption. However, owing to the service characteristic of quasi-periodicity as well as large and various data amount, the preconfigured resource may miss data or may be not enough for data transmission.

### SUMMARY

The present disclosure relates to methods, devices, and computer program products for resource indication.

One aspect of the present disclosure relates to a wireless communication method. In an embodiment, the wireless communication method includes: receiving, by a wireless communication terminal from a wireless communication node, first control signaling; determining, by the wireless communication terminal, one or more scheduled resources according to the first control signaling; and performing, by the wireless communication terminal, a transmission of uplink data or a reception of downlink data via the one or more scheduled resources.

Another aspect of the present disclosure relates to a wireless communication method. In an embodiment, the wireless communication method includes: transmitting, by a wireless communication node to a wireless communication terminal, a first control signaling to allow the wireless communication terminal to determine one or more scheduled resources according to the first control signaling and allow the wireless communication terminal to perform a transmission of uplink data or a reception of downlink data via the one or more scheduled resources.

Another aspect of the present disclosure relates to a wireless communication terminal. In an embodiment, the wireless communication terminal includes a communication unit and a processor. The processor is configured to: receive, from a wireless communication node, first control signaling; determine one or more scheduled resources according to the first control signaling; and perform a transmission of uplink data or a reception of downlink data via the one or more scheduled resources.

Another aspect of the present disclosure relates to a wireless communication node. In an embodiment, the wireless communication node includes a communication unit and a processor. The processor is configured to: transmit, to a wireless communication terminal, a first control signaling to allow the wireless communication terminal to determine one or more scheduled resources according to the first control signaling and allow the wireless communication terminal to perform a transmission of uplink data or a reception of downlink data via the one or more scheduled resources.

In some embodiments, various embodiments may implement the following features:

In some embodiments, the transmission of the uplink data is based on second control signaling.

In some embodiments, the reception of the downlink data is based on third control signaling.

In some embodiments, the first control signaling comprises one or more effect time durations for an indication conveyed by second control signaling or third control signaling.

In some embodiments, the second control signaling is at least one of: Radio Resource Control, RRC, signaling; Medium Access Control Control Element, MAC CE; Uplink Control Information, UCI, or a reference signal.

In some embodiments, the UCI comprises at least one of a scheduling request, SR, or a Channel State Information, CSI, report.

In some embodiments, the UCI comprises a configured grant UCI.

In some embodiments, the reference signal for different indications comprises at least one of a demodulation reference signal, DM-RS; a sounding reference signal, SRS; a phase track reference signal, PT-RS.

In some embodiments, the reference signal for different indications are orthogonal through at least one of: sequence initialization parameters; code division multiplexing, CDM, groups; scrambling in the frequency domain; scrambling in the time domain; or transmission resources.

In some embodiments, the second control signaling comprises at least one of: an effect time duration; one or more valid or invalid indications of the one or more scheduled resources, one or more locations of the one or more scheduled resources for data transmission; a buffer size indication; a priority indication; delta modulation and coding scheme; a time domain resource assignment; or a frequency domain resource assignment.

In some embodiments, the effect time duration indicated by the second control signaling is one of the one or more effect time duration comprised in the first control signaling.

In some embodiments, a starting position of the effect time duration is determined by at least one of the position of the second control signaling or an offset.

In some embodiments, a starting position of the effect time duration is a scheduled resource after the second control signaling.

In some embodiments, the one or more scheduled resources with invalid indications are skipped for data transmission. E.g., the wireless communication terminal skips the one or more scheduled resources with invalid indications for data transmission.

In some embodiments, the one or more scheduled resources with invalid indications are skipped for data reception. E.g., the wireless communication node skips the one or more scheduled resources with invalid indications for data reception.

In some embodiments, the one or more locations of the one or more scheduled resources for data transmission indicate at least one of a starting resource or an ending resource among the one or more scheduled resources.

In some embodiments, the starting resource indication is not transmitted, one or more scheduled resources are skipped for data transmission. E.g., when the starting resource indication is not transmitted in the second control signaling, the wireless communication terminal skips the one or more scheduled resources for data transmission.

In some embodiments, the starting resource indication is not received, one or more scheduled resources are skipped for data reception. E.g., when the starting resource indication is not received in the second control signaling, the wireless communication node skips the one or more scheduled resources for data reception.

In some embodiments, the ending resource indication is transmitted, one or more scheduled resources are skipped for data transmission. E.g., when the ending resource indication is transmitted in the second control signaling, the wireless communication terminal skips the one or more scheduled resources for data transmission.

In some embodiments, the ending resource indication is received, one or more scheduled resources are skipped for data reception. E.g., when the ending resource indication is received in the second control signaling, the wireless communication node skips the one or more scheduled resources for data reception.

In some embodiments, the buffer size indication indicates a request size of data in the one or more scheduled resources.

In some embodiments, the length of buffer size indication is associated with a logical channel group indication.

In some embodiments, the logical channel group indication is determined by at least one of MAC CE or UCI.

In some embodiments, the priority indication indicates a priority of the one or more scheduled resources to allow data transmission via the scheduled resources when a collision occurs.

In some embodiments, the third control signaling is at least one of: Radio Resource Control, RRC, signaling; Medium Access Control Control Element, MAC CE; Downlink Control Information, DCI, or a reference signal.

In some embodiments, the DCI comprises at least one block set, the block set comprises one or more blocks, each block is associated with at least one of: one or more configurations, one or more configuration sets, one or more user equipments, one or more serving cells, or one or more serving cell groups.

In some embodiments, the configuration set comprises one or more configurations, and the configurations comprises one or more scheduled resources.

In some embodiments, location information of the blocks in the DCI is determined by at least one of: one or more high layer parameters or one or more bit widths of one or more information fields.

In some embodiments, the DCI comprises at least one of the following re-interpreted information fields to determine configurations: Hybrid Automatic Repeat Request, HARQ, Process Number; Redundancy version; Time domain resource assignment; Frequency domain resource assignment; Modulation and coding scheme, MCS; Downlink assignment index; Transmit Power Control, TPC, command for scheduled Physical Uplink Control Channel, PUCCH; or Virtual Resource Blocks to Physical Resource Blocks, VRB-to-PRB, mapping.

In some embodiments, the at least one of the information fields of the DCI is re-interpreted in response to at least one of:
one or more high layer parameters; or
at least one of the following information fields being set to a predefined value: HARQ Process Number; Redundancy version; Time domain resource assignment; Frequency domain resource assignment; MCS; Downlink assignment index; TPC command for scheduled PUCCH; or VRB-to-PRB mapping.

In some embodiments, the reference signal comprises at least one of a demodulation reference signal, DM-RS; a sounding reference signal, SRS; a phase track reference signal, PT-RS; a CSI reference signal, CSI-RS; or a remote interference management reference signal, RIM-RS.

In some embodiments, the reference signal for different indications are orthogonal through at least one of: sequence initialization parameters; code division multiplexing, CDM, groups; scrambling in the frequency domain; scrambling in the time domain; or transmission resources.

In some embodiments, the third control signaling comprises at least one of: an effect time duration; one or more valid or invalid indications of the one or more scheduled resources, one or more locations of the one or more scheduled resources for data reception; or an interval between the third control signaling and the one or more scheduled resources.

In some embodiments, the effect time duration indicated by the third control signaling is one of the one or more effect time duration comprised in the first control signaling.

In some embodiments, the effect time duration indicated by the third control signaling is one of the one or more effect time duration comprised in the first control signaling.

In some embodiments, a starting position of the effect time duration is determined by at least one of the position of the third control signaling or an offset.

In some embodiments, a starting position of the effect time duration is a scheduled resource after the third control signaling.

In some embodiments, the starting resource indication is not received, one or more scheduled resources are skipped for data reception. E.g., when the starting resource indication is not received in the third control signaling, the wireless communication terminal skips the one or more scheduled resources for data reception.

In some embodiments, the starting resource indication is not transmitted, one or more scheduled resources are skipped for data transmission. E.g., when the starting resource indication is not transmitted in the third control signaling, the wireless communication node skips the one or more scheduled resources for data transmission.

In some embodiments, the ending resource indication is received, one or more scheduled resources are skipped for data reception. E.g., when the ending resource indication is received in the third control signaling, the wireless communication terminal skips the one or more scheduled resources for data reception.

In some embodiments, the ending resource indication is transmitted, one or more scheduled resources are skipped for data transmission. E.g., when the ending resource indication is transmitted in the third control signaling, the wireless communication node skips the one or more scheduled resources for data transmission.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an SPS configuration pattern according to an embodiment of the present disclosure.

FIG. 2 shows a CG configuration pattern according to an embodiment of the present disclosure.

FIG. 3 shows resource allocation according to an embodiment of the present disclosure.

FIG. 4 shows a flowchart for granting uplink resource according to an embodiment of the present disclosure.

FIGS. 5 to 20 show resource indication methods according to embodiments of the present disclosure.

FIG. 21 shows an example of a schematic diagram of a wireless communication terminal according to an embodiment of the present disclosure.

FIG. 22 shows an example of a schematic diagram of a wireless communication node according to an embodiment of the present disclosure.

### DETAILED DESCRIPTION

One aspect of the discourse provides a quick resource indication method.

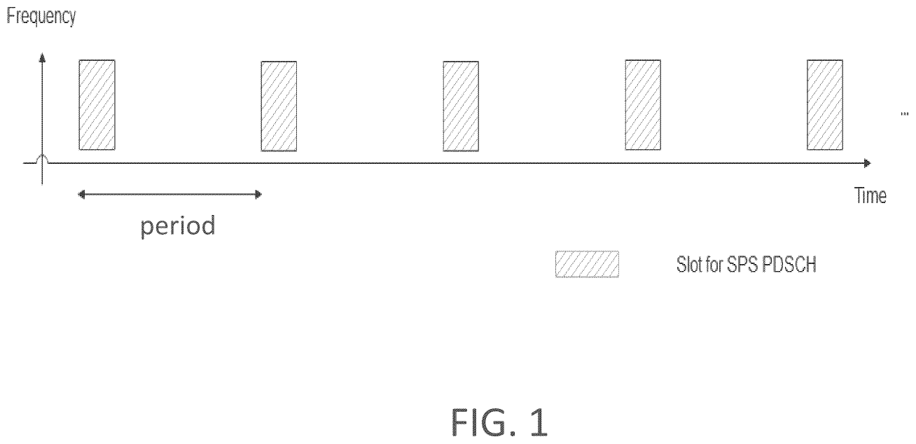

FIG. 1 shows an SPS configuration pattern according to an embodiment of the present disclosure.

For the semi-persistent scheduling (SPS) transmission, the gNB (gNodeB) transmits a Radio Resource Control (RRC) signaling to the UE (user equipment) including an SPS configuration, which includes the periodicity, the modulation and coding scheme (MCS) level, information of the physical uplink control channel (PUCCH) resource and so on. Then, the gNB transmits an activation DCI to the UE to activate the SPS configuration. The gNB is capable of transmitting data via the physical downlink shared channel (PDSCH) based on the periodicity determined by the SPS configuration without monitoring the physical downlink control channel (PDCCH). While the gNB transmits a release DCI to stop transmitting the pre-scheduled PDSCH, the SPS configuration is released.

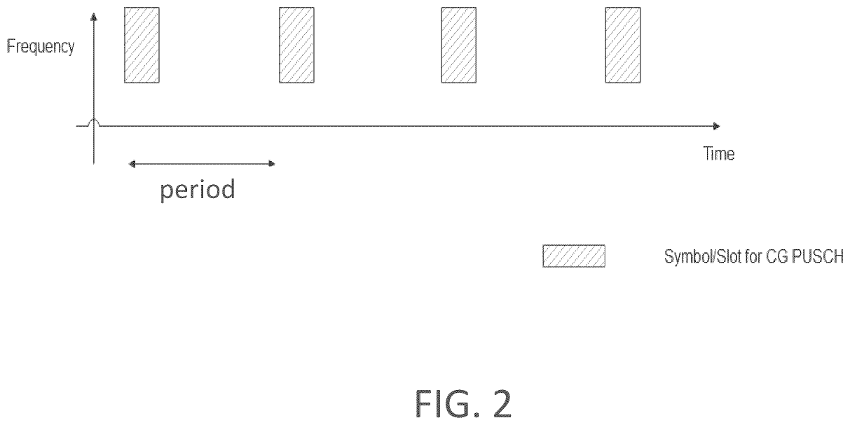

FIG. 2 shows a CG configuration pattern according to an embodiment of the present disclosure.

In an embodiment, uplink configured grant (CG) transmission includes two types.

For the type-1 CG, the user equipment (UE) receives a radio resource control (RRC) signaling (e.g., configuredGrantConfig) from the gNB, where the periodicity, the resource assignment information, modulation and the coding scheme (MCS) table/level and other scheduling information are included. Then, after an offset determined by configuredGrantConfig, the type-1 CG is activated. The UE transmits data via physical uplink shared channel (PUSCH) based on the periodicity determined by configuredGrantConfig without the grant request. While the UE receives a release downlink control information (DCI) to stop transmitting the data via the granted PUSCH, the type-1 CG is released.

For the type-2 CG, the UE also receives an RRC signaling (e.g., configuredGrantConfig) from the gNB. Then, an activation DCI is received by the UE from the gNB to activate the type-2 CG. The UE transmits data via PUSCH based on the periodicity determined by configuredGrantConfig without the grant request. While the UE receives a release DCI to stop transmitting data via the granted PUSCH, the type-2 CG is released.

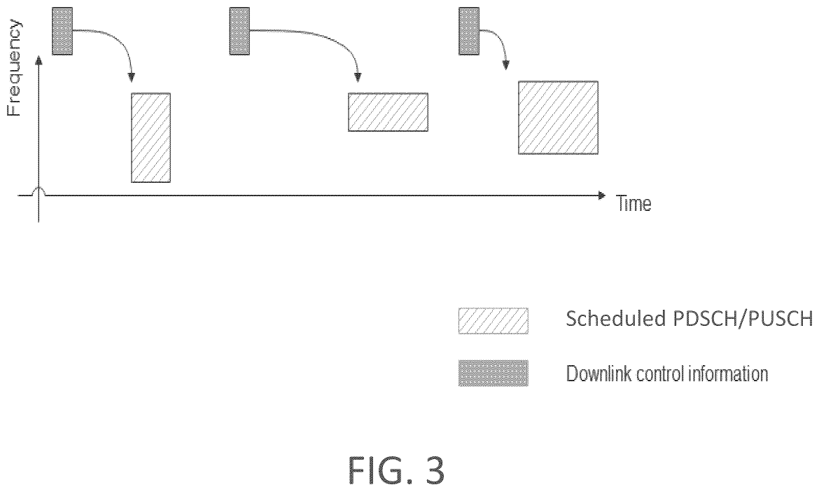

FIG. 3 shows downlink resource allocation according to an embodiment of the present disclosure. As illustrated in FIG. 3, the PDSCHs are scheduled by the downlink control information.

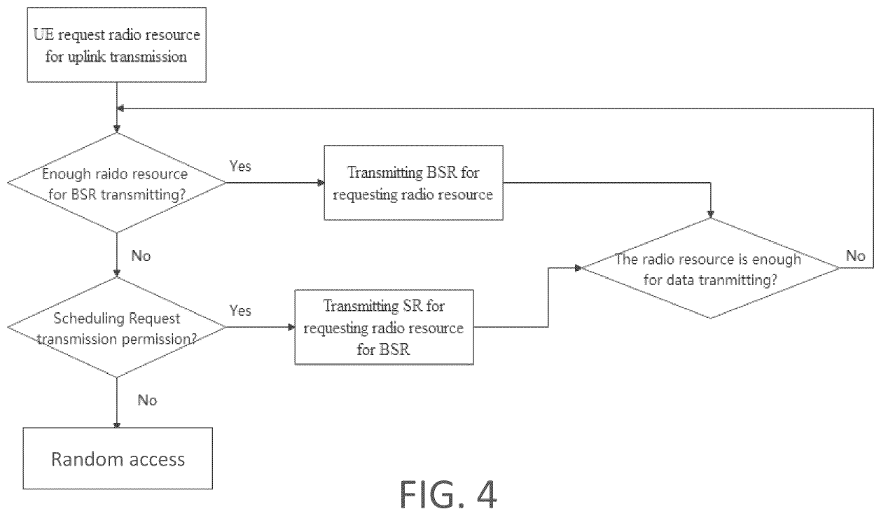

FIG. 4 shows a flowchart for granting uplink resource according to an embodiment of the present disclosure. As illustrated in FIG. 4, the Scheduling request (SR) and buffer status reporting (BSR) are used for uplink resource granting.

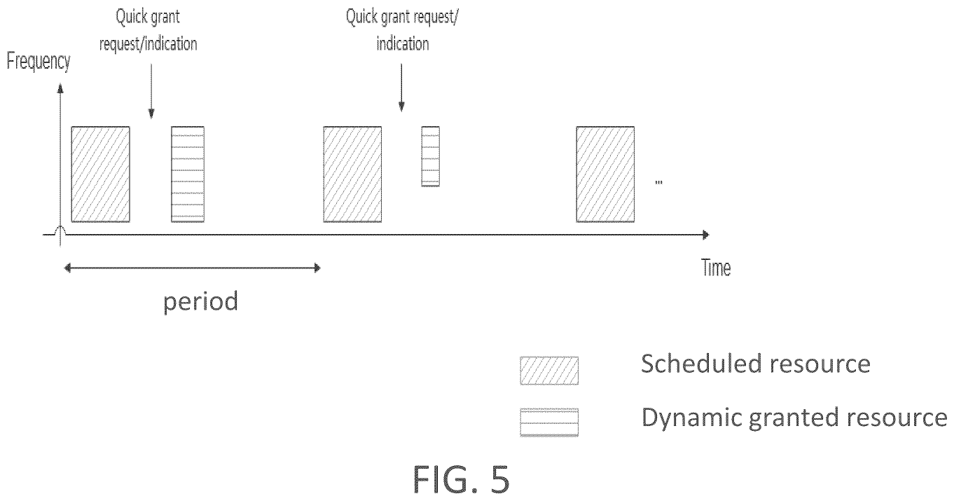

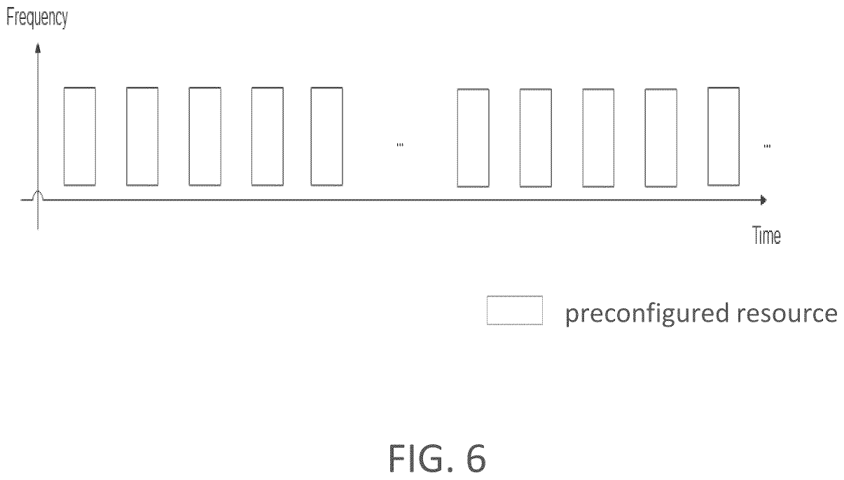

In order to have more transmission occasions for packets with large data and mitigate the jitter impact on the offset between packet arrival the preconfigured resources, dynamic granted resource (see FIG. 5) or redundant preconfigured resources (see FIG. 6) may be used.

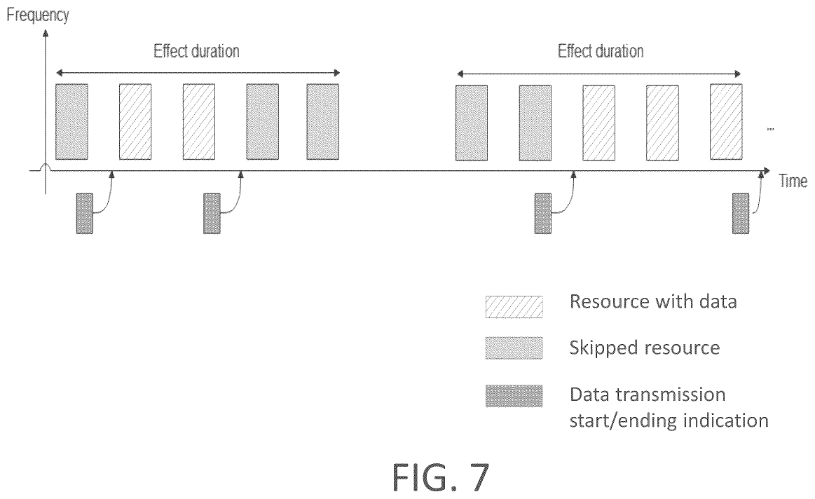

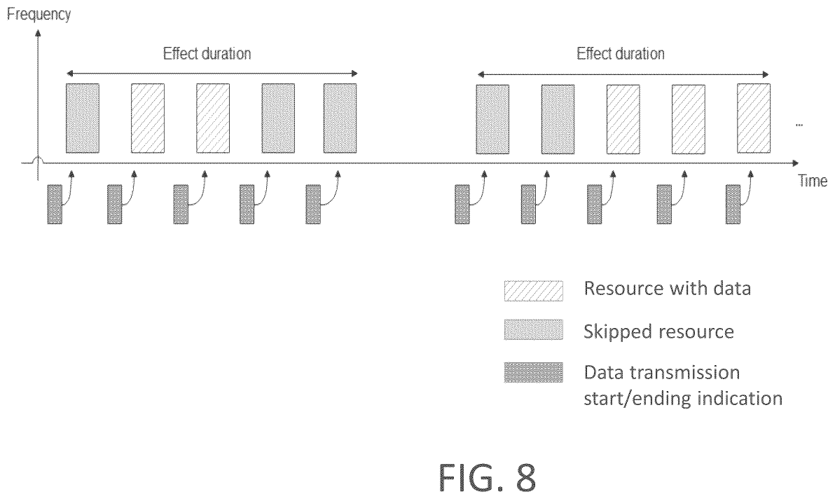

Besides, when redundant resources are preconfigured, the receiver may detect the scheduled resources frequently even if there is no data transmission, which causes resource waste and power consumption. In some embodiments, transmission occasion skipping mechanisms (see FIG. 7 and FIG. 8) are provided to save resource and reduce power consumption.

In an embodiment, one or more configurations are used to configure one or more scheduled resources. In an embodiment, the configurations include at least one of SPS configuration for downlink transmission and/or CG configuration for uplink transmission. In an embodiment, the scheduled resources include at least one of SPS resources (e.g., via PDSCH) (also referred to as SPS PDSCH) for downlink transmission and/or CG resource (e.g., via PUSCH) (also referred to as CG PUSCH) for uplink transmission. In an embodiment, the scheduled resources include time occasions for uplink and/or downlink transmission.

In an embodiment, a wireless communication method includes: receiving, by a wireless communication terminal (e.g., a UE) from a wireless communication node (e.g., a gNB), a first control signaling; determining, by the wireless communication terminal, one or more scheduled resources according to the first control signaling; and performing, by the wireless communication terminal, a transmission of uplink data or a reception of downlink data via the one or more scheduled resources.

In an embodiment, the transmission of the uplink data is based on second control signaling. In an embodiment, the reception of the downlink data is based on third control signaling.

In the paragraphs below, details of the first control signaling (also referred to as the first signaling), the second control signaling (also referred to as the second signaling), the third control signaling (also referred to as the third signaling), the scheduled resources in some embodiments are described, but the present disclosure is not limited thereto.

In some embodiments, the first control signaling includes at least one of the following: RRC (Radio Resource Control) signaling; MAC CE (Medium Access Control Control Element) signaling; and/or DCI (Downlink Control Information) signaling.

In some embodiments, the first control signaling includes one or more effect time durations for an indication conveyed by second control signaling or third control signaling. In other words, for an indication conveyed by the second signaling or the third signaling, it only applied within the effect time duration.

In some embodiments, the second control signaling includes at least one of: RRC signaling; MAC CE signaling; UCI (Uplink Control Information) signaling, and/or a reference signaling.

In some embodiments, the UCI signaling includes at least one of scheduling request (SR) and/or a Channel State Information (CSI) report.

In some embodiments, the UCI signaling includes a configured grant UCI, but is not limited to this.

In some embodiments, the reference signaling for different indications includes at least one of a demodulation reference signal (DM-RS); a sounding reference signal (SRS); a phase track reference signal (PT-RS).

In some embodiments, the reference signaling for different indications are orthogonal through at least one of: sequence initialization parameters; code division multiplexing (CDM) groups; scrambling in the frequency domain; scrambling in the time domain; or transmission resources. In some cases, the resources are time domain resources. In some cases, the resources are frequency domain resources.

In some embodiments, the second control signaling includes at least one of: an effect time duration preconfigured (see FIGS. 7 and 8); one or more valid or invalid indications of the one or more scheduled resources, one or more locations of the one or more scheduled resources for data transmission; a buffer size indication; a priority indication; delta modulation and coding scheme (MCS) information; a time domain resource assignment, or a frequency domain resource assignment.

In some embodiments, the effect time duration indicated by the second control signaling is one of the one or more effect time duration comprised in the first control signaling.

In other words, multiple effect time is configured in the first control signaling. The second control signaling is used to configure one of multiple effect time durations as its effect time duration.

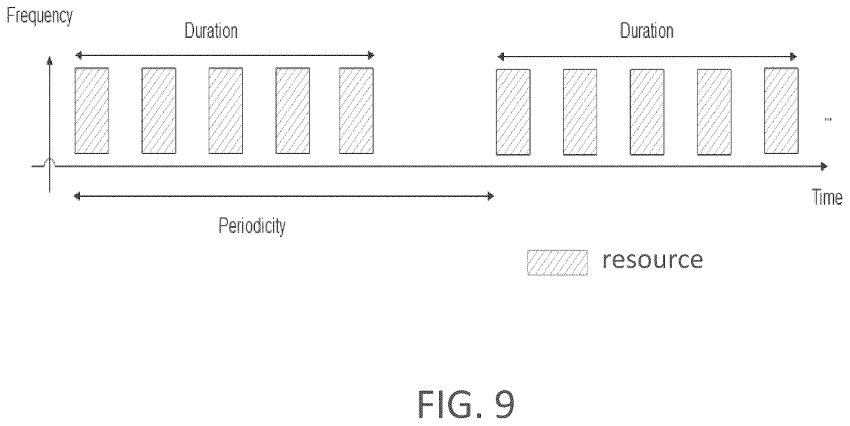

Referring to FIG. 9, in some embodiments, the effect time duration is at least one of a number of symbols, a number of slots, or a number of HARQ process identifiers.

In some embodiments, a starting position of the effect time duration is determined by at least one of the positions of the second control signaling or an offset. In some embodiments, a starting position of the effect time duration is a first scheduled resource after the second control signaling.

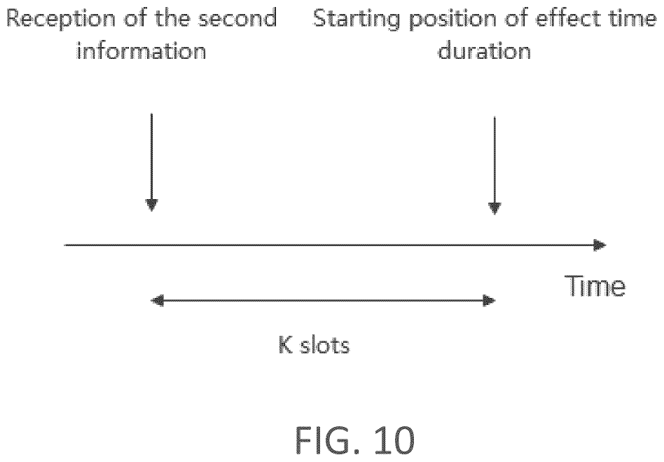

For example, as illustrated in FIG. 10, the starting position of the effect time duration is determined by the position of the second control signaling. The second control signaling comprises a value K for determining the starting position of the effect time duration is K slots after it has been received.

In some embodiment, the value K is configured by high layer parameter, e.g., RRC signaling, as an offset.

In some embodiments, the one or more scheduled resources with invalid indications are not used for transmitting the data. For example, if a scheduled resource is indicated as an invalid resource (e.g., with an invalid indication), the UE skips this resource, and does not detect and/or decode the data in this resource. If a scheduled resource is indicated as a valid resource (e.g., with a valid indication), the UE detects and/or decodes the data in this resource.

In some approaches, configured grant transmission is used. The periodicity of configured grant is small in order to transmit large and various packet size service with jitter impact (see FIG. 6).

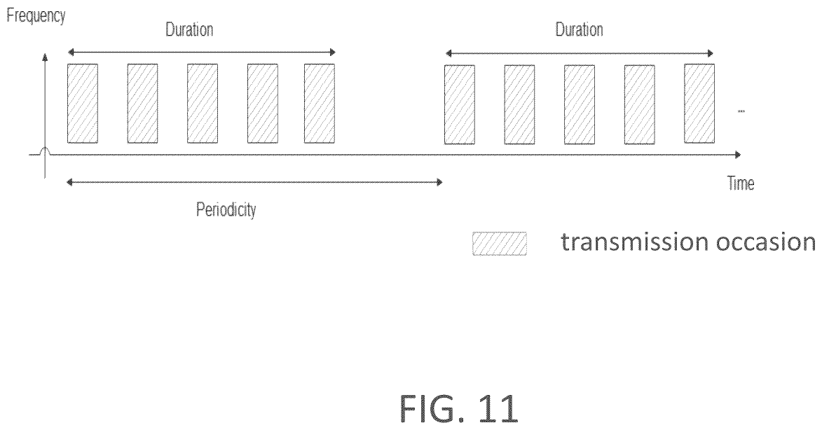

In some embodiment, configured grant transmission is characterized by multiple transmission occasions in one duration (see FIG. 11).

In this case, the second control signaling is used to indicate the scheduled resources with data transmission. Besides, the second control signaling indicates the validity of scheduled resource.

In some cases, the second control signaling is UCI. The valid scheduled resources mean there is data transmitting via the scheduled resource. The invalid scheduled resources mean there is no data transmitting in the scheduled resource. The periodicity of UCI transmission is the same as the periodicity of the configured grant transmission, or is the same as the periodicity of the scheduled resource in the duration.

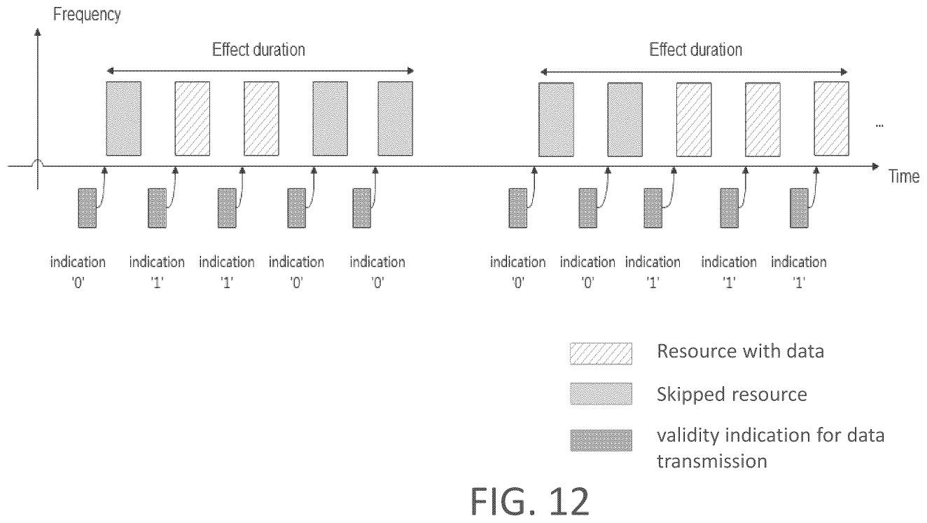

In some cases, the UCI is SR (scheduling request). The SR carries one bit to carry the validity of scheduled resource. From the UE's perspective, bit ‘1’ indicates the scheduled resource is valid, and UE transmits data in this scheduled resource, while bit ‘0’ indicates the scheduled resource is invalid, and UE does not transmit data in this scheduled resource. While from the gNB's perspective, if SR having validity indication with value ‘1’ is received, gNB detects and decodes the data in this scheduled resource, or if SR having validity indication with values ‘0’ is received, the gNB skips the scheduled resource without detecting and decoding (see FIG. 12).

| Value | Description |
|---|---|
| ‘1’ | Valid scheduled resource |
| ‘0’ | Invalid scheduled resource |

In some cases, the reference signal is DM-RS. The DM-RS transmits in every scheduled resources. From UE's perspective, data and DM-RS is transmitted via the same scheduled resources while only DM-RS is transmitted via some scheduled resources. From gNB's perspective, DM-RS detection is in every scheduled resources.

In this case, the DM-RS indicating valid scheduled resource and that indicating invalid scheduled resource are orthogonal. The orthogonality is based on at least one of the following:
Sequence Initialization parameter: Re-defined n̅_{SCID}^{λ̅} and λ̅ are expressed as:

$${\overline{n}}_{SCID}^{\overline{λ}} = \{ \begin{matrix}{n}_{SCID} & λ = 1 \\ 1 - {n}_{SCID} & λ = 0 or λ = 2\end{matrix}$$

Valid scheduled resource indication DM-RS: λ=1

Invalid scheduled resource indication DM-RS: λ=0 or λ=2

### Scrambling Method

DM-RS mapping to physical resource can be express as:

$${\tilde{a}}_{k , l}^{( {\tilde{ρ}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , υ - 1$$

when transform precoding is not enabled; or

$${\tilde{a}}_{k , l}^{( {\tilde{ρ}}_{0} , μ )} = {w}_{f} ( {k}^{′} ) {w}_{t} ( {l}^{′} ) r ( 2 n + {k}^{′} )$$

$$k = 4 n + 2 {k}^{′} + Δ$$

$${k}^{′} = 0 , 1$$

$$l = \overline{l} + {l}^{′}$$

$$n = 0 , 1 , …$$

when transform precoding is enabled.
A. CDM group
   Valid scheduled resource indication DM-RS: CDM group=0
   Invalid scheduled resource indication DM-RS: CDM group=1
   or
   Valid scheduled resource indication DM-RS: CDM group=1
   Invalid scheduled resource indication DM-RS: CDM group=0
B. Frequency orthogonality
   Valid scheduled resource indication DM-RS: w_{f}^{(k′)}=+1 (k′=0)
   Invalid scheduled resource indication DM-RS: w_{f}^{(k′)}=−1 (k′=1)
   or
   Valid scheduled resource indication DM-RS: w_{f}^{(k′)}=−1 (k′=1)
   Invalid scheduled resource indication DM-RS: w_{f}^{(k′)}=+1 (k′=0)
C. Time orthogonality
   Valid scheduled resource indication DM-RS: wₜ^{(l′)}=+1 (I′=0)
   Invalid scheduled resource indication DM-RS: wₜ^{(l′)}=−1 (I′=1)
   or
   Valid scheduled resource indication DM-RS: wₜ^{(l′)}=−1 (I′=1)
   Invalid scheduled resource indication DM-RS: wₜ^{(l′)}=+1 (I′=0)
D. Transmission resource
   Valid scheduled resource indication DM-RS: Δ=0
   Invalid scheduled resource indication DM-RS: Δ=1
   or
   Valid scheduled resource indication DM-RS: Δ=1
   Invalid scheduled resource indication DM-RS: Δ=0

In some cases, the reference signal is SRS. The SRS transmits in every scheduled resources. From the UE's perspective, data and SRS is transmitted via the same scheduled resources while only SRS is transmitted via some scheduled resources. From the gNB's perspective, SRS detection is in every scheduled resources.

### Sequence Initialization Parameter

The sequence initialization of SRS is expressed as:

The cyclic shift αᵢ for antenna port pᵢ is given as:

$${α}_{i} = 2 π \frac{{n}_{SRS}^{cs , i}}{{n}_{SRS}^{cs , max}}$$

$${n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} ,$$

where n_{SRS}^{cs}∈{0, 1, . . . , n_{SRS}^{cs,max}−1} is contained in the higher layer parameter transmissionComb. The maximum number of cyclic shifts n_{SRS}^{cs,max} are predetermined, and where e denotes cyclic shift while pᵢ denotes antenna port.
Valid scheduled resource indication SRS: n_{SRS}^{cs}∈{0, 1, . . . , n_{SRS}^{cs,max}−1}: 0
Invalid scheduled resource indication SRS: n_{SRS}^{cs}∈{0, 1, . . . , n_{SRS}^{cs,max}−1}: 1
Or
Valid scheduled resource indication SRS: n_{SRS}^{cs}∈{0, 1, . . . , n_{SRS}^{cs,max}−1}: 1
Invalid scheduled resource indication SRS: n_{SRS}^{cs}∈{0, 1, . . . , n_{SRS}^{cs,max}−1}: 0

### SRS Resource

SRS with different indication are orthogonal through frequency-domain starting position.

The frequency-domain starting position is expressed as:

$${k}_{0}^{( {p}_{i} )} = {\overline{k}}_{0}^{( {p}_{i} )} + {\sum }_{b = 0}^{{B}_{SRS}} {K}_{TC} {M}_{sc , b}^{SRS} {n}_{b}$$

where

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC}$$

$${k}_{TC}^{( {p}_{i} )} = \{ \begin{matrix}\begin{matrix}( {\overline{k}}_{TC} + {K}_{TC} / 2 ) mod {K}_{TC} \\ \end{matrix} & \begin{matrix}if {n}_{SRS}^{cs} ∈ \{ {n}_{SRS}^{cs , max} / 2 , … , {n}_{SRS}^{cs , max} - 1 \} and \\ {N}_{ap}^{SRS} = 4 and {p}_{i} ∈ \{ 1001 , 1003 \}\end{matrix} \\ {\overline{k}}_{TC} & otherwise\end{matrix}$$

Valid scheduled resource indication SRS: k̅₀^{(p}^{ᵢ}⁾=n_{shift}N_{sc}^{RB}+(k_{TC}^{(p}^{ᵢ}⁾+k_{offset}^{l′}) mod K_{TC} k_offset=0
Invalid scheduled resource indication SRS: k̅₀^{(p}^{ᵢ}⁾=n_{shift}N_{sc}^{RB}+(k_{TC}^{(p}^{ᵢ}⁾+k_{offset}^{l′}) mod K_{TC} k_offset=1
Valid scheduled resource indication SRS: k̅₀^{(p}^{ᵢ}⁾=n_{shift}N_{sc}^{RB}+(k_{TC}^{(p}^{ᵢ}⁾+k_{offset}^{l′}) mod K_{TC} k_offset=1
Invalid scheduled resource indication SRS: k̅₀^{(p}^{ᵢ}⁾=n_{shift}N_{sc}^{RB}+(k_{TC}^{(p}^{ᵢ}⁾+k_{offset}^{l′}) mod K_{TC} k_offset=0

In some embodiments, the one or more locations of the one or more scheduled resources transmitting the data indicate at least one of a starting resource or an ending resource among the one or more scheduled resources. For example, if a scheduled resource indicated to a starting resource for transmitting the data, the UE may detect and/or decode the data in this resource and skip the prescheduled resource(s) before the starting resource. If a scheduled resource indicated to a starting resource for transmitting the data, the UE may detect and/or decode the data in this resource and skip the prescheduled resource(s) after the ending resource.

In some embodiments, the starting resource indication is not transmitted, one or more scheduled resources are skipped for data transmission. In some embodiments, the ending resource indication is transmitted, one or more scheduled resources are skipped for data transmission.

In some embodiments, a scheduled resource is skipped for data transmission means the UE would not transmit data in this scheduled resource. For the gNB, the gNB would not detect and decode data in this scheduled resource.

In this case, the second control signaling is used to indicate the scheduled resource with data transmission. And the second control signaling indicates the location of scheduled resource for data transmission. The location of scheduled resource for data transmission means the scheduled resource for data transmission is the first scheduled resource for data transmission or is the last scheduled resource for data transmission.

In some cases, the second control signaling is UCI. In this case, from the UE's perspective, if there is no data transmission in the scheduled resource in the effect time duration, UE does not transmit the UCI to gNB and UE does not transmit the data via corresponding scheduled resource. If data transmission starts, UE transmits the UCI for gNB to inform gNB the corresponding scheduled resource is the starting scheduled resource for data transmission. And UE transmits data in corresponding scheduled resource. If data transmission finishes, UE transmits the UCI for gNB to inform gNB the corresponding scheduled resource is the ending scheduled resource for data transmission. After that, UE does not transmit data in the scheduled resource in the effect duration. From the gNB's perspective, if the UCI indicating the starting scheduled resource is not received, gNB does not detect and decode the data in this scheduled resource and releases the resource. If the UCI indicating the starting scheduled resource is received, gNB starts to detect and decode the data in the following scheduled resource until the UCI indicating the ending scheduled resource is received. If the UCI indicating the ending scheduled resource for data transmission is received, gNB does not detect and decode the data in the scheduled resources behind the ending scheduled resource for data transmission and releases these scheduled resources in the effect duration.

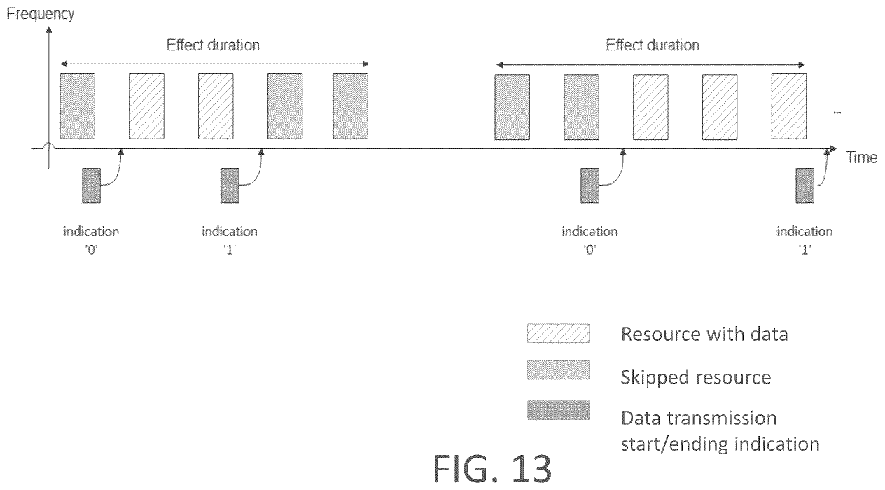

In some cases, the UCI is SR. In this case, SR carries one bit to carry the location of scheduled resource. From UE's perspective, bit ‘0’ indicates the scheduled resource is the starting scheduled resource for data transmission, while bit ‘1’ indicates the scheduled resource is the ending scheduled resource for data transmission. While from gNB's perspective, if SR with value ‘0’ indication, gNB detects and decodes the data in this scheduled resource, or if SR with values ‘1’ indication, gNB skips the scheduled resource without detecting and decoding (see FIG. 13).

| Value | Description |
|---|---|
| ‘1’ | Starting scheduled resource for data transmission |
| ‘0’ | Ending scheduled resource for data transmission |

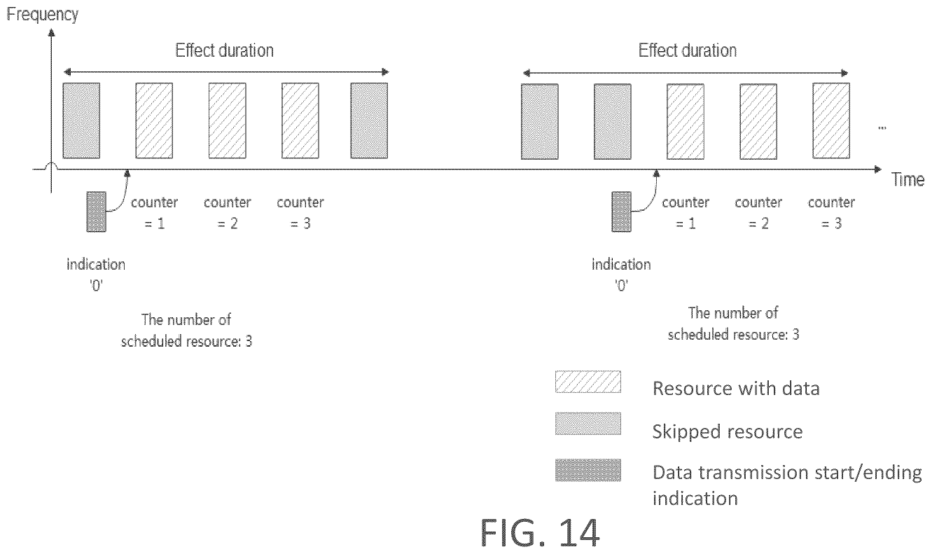

In some cases, as illustrated in FIG. 14, the UCI indicates the starting scheduled resource for data transmission while MAC CE indicates the ending scheduled resource for data transmission by at least a number of scheduled resource associated with a counter. When starting scheduled resource is indicated, the counter starts to increase or decrease. If counter increases to the number of resources determined by MAC CE, or decrease to zero, UE does not transmit data in the scheduled resource in the effect duration. And gNB does not detect and decode the data in the scheduled resources behind the ending scheduled resource for data transmission and releases these scheduled resources in the effect duration.

In some cases, the indication includes starting scheduled resource for data transmission indication and ending scheduled resource for data transmission indication, or only the ending scheduled resource for data transmission indication.

In some embodiments, the reference signal determines the starting scheduled resource for data transmission and the ending scheduled resource for data transmission. The indication is carried by sequence initialization parameters; code division multiplexing (CDM) groups; scrambling in the frequency domain; scrambling in the time domain; or transmission resources. The reference signal comprises DM-RS, SRS and PT-RS. Many aspects of the reference signal determining the starting scheduled resource for data transmission and the ending scheduled resource for data transmission are similar to those of the reference signal indicating the scheduled resource is valid or invalid described above, and can be ascertained by referring to the embodiments above.

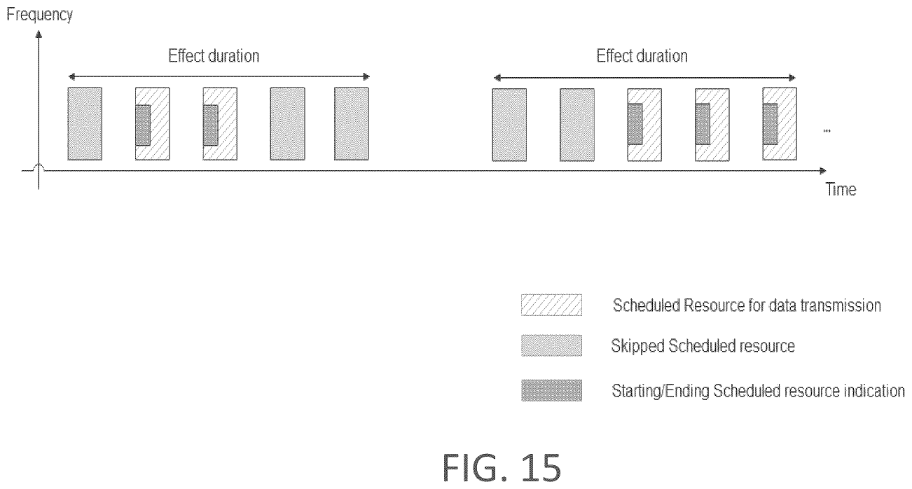

In some cases, the reference signal with the starting scheduled resource for data transmission indication transmits in every scheduled resources for data transmission except the last scheduled resource for data transmission. While reference signal with the ending scheduled resource for data transmission indication transmits in the last scheduled resource for data transmission. When the gNB detects the reference signal with the ending scheduled resource for data transmission indication, the gNB skips and release the following scheduled resource in the effect time duration (see FIG. 15).

In some embodiments, the buffer size indication indicates a request size of the uplink data or downlink data in the one or more scheduled resources (see FIG. 5). In some embodiments, the buffer size indication is multiplexing with the PUCCH (physical uplink control channel) and/or the PUSCH (physical uplink shared channel).

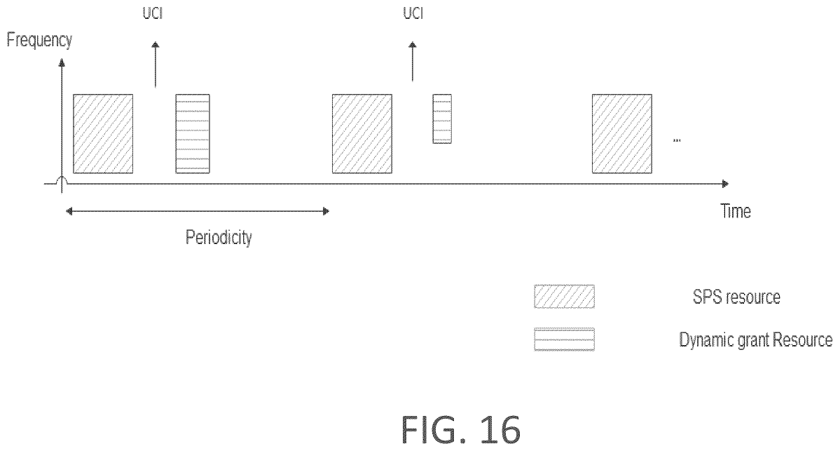

In some embodiments, the length of buffer size indication is associated with a logical channel group indication. In some embodiments, the logical channel group indication is determined by MAC CE and/or UCI (see FIG. 16).

In some embodiments, the UCI is SR. The length of SR is associated with the length of buffer size indication.

In some cases, the length of SR is equal to the length of buffer size indication. For example, if the logical group indication indicates ‘0’, which means there is only one logical channel group for data transmission. The length of SR is 5-bit length. If the logical channel group indication indicates ‘1’, which means there are more than one logical channel groups for data transmission. Then length of SR is 8-bit length.

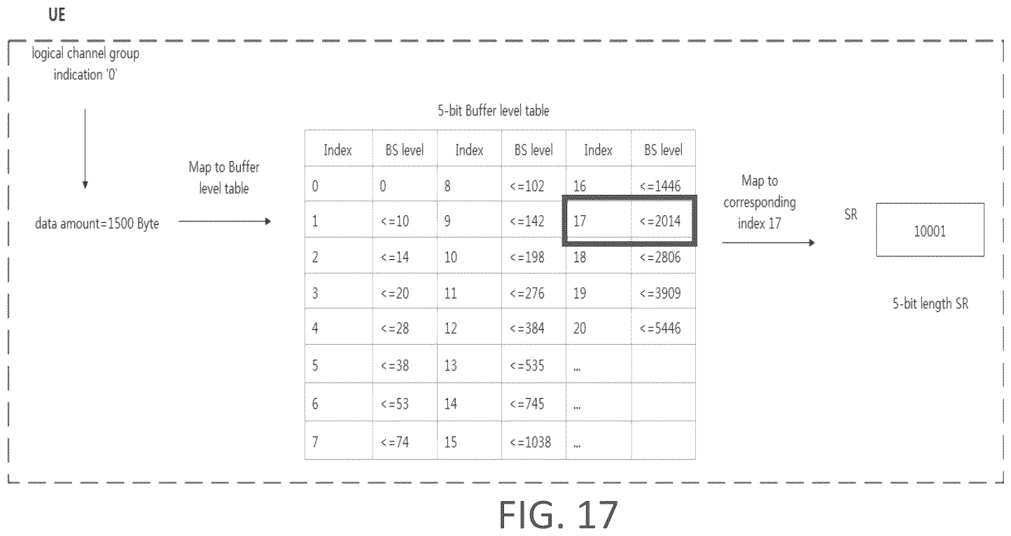

In this case, the SR carries the index of a buffer level table. An example procedure is depicted in FIG. 17.

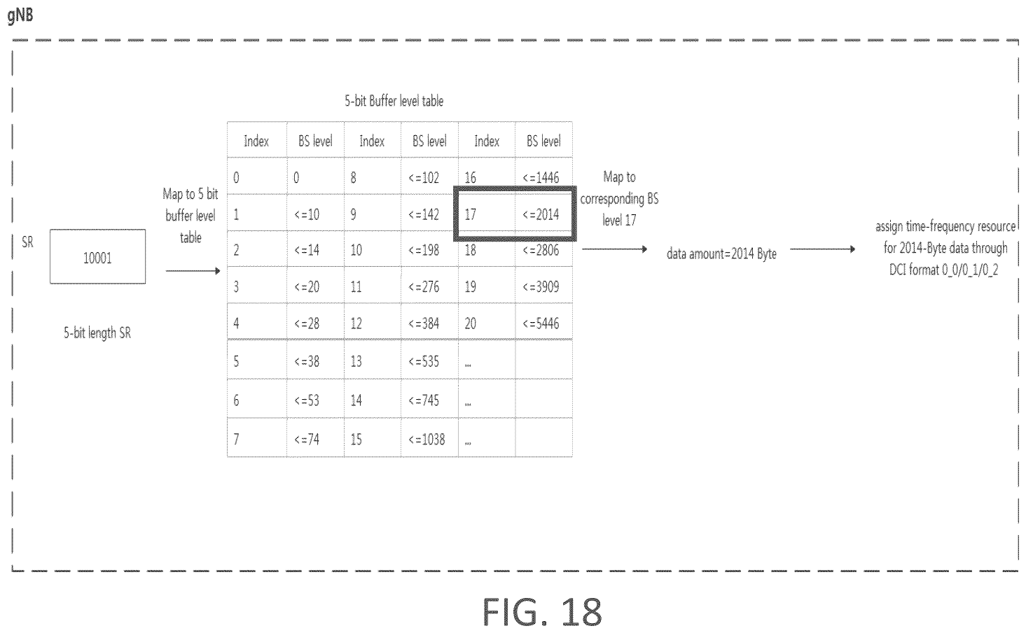

The gNB detects and decodes the SR and obtains data amount according to the index. And then gNB allocates the PUSCH resource for UE based on informed data amount through DCI format 0_0/0_1/0_2. An example procedure is depicted in FIG. 18.

In some embodiments, a transmission of SR is multiplexing with PUCCH by PUCCH format 2, PUCCH format 3 or PUCCH format 4. The UCI information including the SR has the following types:
1) HARQ-ACK information and SR

The UCI information has SR signaling following the HARQ-ACK information.
2) HARQ-ACK information, SR and CSI report

The UCI information has HARQ-ACK information, SR signaling and CSI report in sequent.

In some embodiments, a transmission of SR is multiplexing with PUCCH by a predefined time-frequency resource.

E.g. the time resource of SR is the first symbol of the PUCCH resource, while the frequency resource of SR is the first K PRBs of the PUCCH resource.

In some embodiments, a transmission of SR is multiplexing with PUSCH.

In some cases, the beta offset of SR information reuses the beta offset of CG-UCI The beta offset is determined by I_{offset}^{CG-UCI} ranging from 0 to 15.

In some cases, a parameter β_{offset}^{SR} is used to configure the start time-frequency resource for SR information. The beta offset for SR information is determined by using the reserved I_{offset}^{CG-UCI} and corresponding beta offset. E.g. I_{offset}^{CG-UCI}=16.

In some embodiments, the priority indication indicates a priority of the one or more scheduled resources to allow data transmission via the scheduled resources when a collision occurs.

In some embodiments, the UCI carries priority indication for indicating the priority of the PUSCH for different service transmission in the same UE. In some cases, the UCI is SR or CSI report.

In some cases, the UCI carries priority indication is one-bit length, where bit ‘1’ denotes the PUSCH is high priority while bit ‘0’ represents the PUSCH is low priority. When two PUSCHs occur collision, the UE transmits PUSCH with ‘1’ priority indication.

| Value | Description |
|---|---|
| ‘1’ | High priority |
| ‘0’ | Low priority |

In some cases, the UCI carries priority indication is more than one bit, the higher priority indication indicates, the PUSCH has the higher priority. E.g. there are 8 level priority for the PUSCH, where UCI carries 3-bit length information.

| Value | Description |
|---|---|
| ‘000’ | Low priority |
| ‘001’ | Level 1 priority |
| ‘010’ | Level 2 priority |
| ‘011’ | Level 3 priority |
| ‘100’ | Level 4 priority |
| ‘101’ | Level 5 priority |
| ‘110’ | Level 6 priority |
| ‘111’ | Level 7 priority |

If the PUSCH with value ‘010’ and the PUSCH with value ‘110’ collide, the UE transmit the PUSCH with value ‘110’.

In some embodiments, the delta MCS information includes at least one of: an adaptive MCS and a fixed resource; or a delta MCS to update an MCS level for the one or more resources.

In some embodiments, the UCI carries delta MCS information to gNB. In some cases, the time-frequency domain resource is fixed. The transmission for uplink data does not finish via the fixed time-frequency domain resource by using MCS level indicated by gNB. To this end, the UE adjusts the MCS level in order to transmit all the data in the fixed time-frequency resource. As a result, a gap between the MCS level of UE adjustment and the MCS level of gNB indication is expressed as a delta MCS information, UE reports delta MCS information for gNB to perform a decoding through an adjusted MCS level.

In some embodiments, the third control signaling includes at least one of: RRC signaling; MAC CE; DCI (Downlink Control Information), or a reference signaling.

The DCI signaling includes at least one block set. In this case, the DCI format may be group common DCI. In some embodiments, the block set includes one or more blocks. Each block is associated with one or more configurations, configuration sets, UEs, serving cells or serving cell groups.

In some embodiments, the configuration set comprises one or more configurations, and the configurations comprises one or more scheduled resources.

In some embodiments, the location information of the blocks in the DCI is determined by at least one of: one or more high layer parameters and/or one or more bit width of one or more information fields.

In some embodiments, the DCI conveying the blocks has at least one of the following characteristics: the DCI format, the DCI size, the RNTI (Radio Network Temporary Identifier) that scrambles the CRC (cyclic redundancy check) bits, and/or the search space set.

In some embodiments, the DCI signaling can be at least one of DCI format 0_0, 1_0, 0_1, 1_1, 0_2, and/or 1_2. In this case, the DCI format is UE specific DCI.

In some embodiments, the DCI carries information described above based on the re-interpretation of at least one of the following information fields: HARQ (Hybrid Automatic Repeat Request) Process Number; Redundancy version; Time domain resource assignment; Frequency domain resource assignment; MCS (Modulation and coding scheme); Downlink assignment index; TPC (Transmit Power Control) command for scheduled PUCCH (Physical Uplink Control Channel); and/or VRB-to-PRB (Virtual Resource Blocks to Physical Resource Blocks) mapping.

In some embodiments, the DCI carries information described above based on the re-interpretation of at least one of the information fields described above when a predefined condition is fulfilled. In an embodiment, the predefined condition includes at least one of an indication of one or more high layer parameters (e.g., via RRC signaling); and/or at least one of the following information fields is set to a predefined value (e.g., all zeros or all ones): HARQ Process Number; Redundancy version; Time domain resource assignment; Frequency domain resource assignment; MCS; Downlink assignment index; TPC command for scheduled PUCCH; and/or VRB-to-PRB mapping.

In some embodiments, the reference signaling in the third signaling includes at least one of a DM-RS; an SRS; a PT-RS; a CSI reference signal (CSI-RS); or a remote interference management reference signal (RIM-RS).

In some embodiments, the reference signaling for different indications are orthogonal through at least one of: sequence initialization parameters; code division multiplexing (CDM) groups; scrambling in the frequency domain; scrambling in the time domain; or transmission resources. In some cases, the resources are time domain resources. In some cases, the resources are frequency domain resources.

In some embodiments, the third control signaling includes at least one of: an effect time duration preconfigured (see FIGS. 7 and 8); one or more valid or invalid indications of the one or more scheduled resources, one or more locations of the one or more scheduled resources for data reception; or an interval between the third control signaling and the one or more second scheduled resources.

In some embodiments, the effect time duration indicated by the third control signaling is one of the one or more effect time duration comprised in the first control signaling.

In some embodiments, a starting position of the effect time duration is determined by at least one of the position of the third control signaling or an offset.

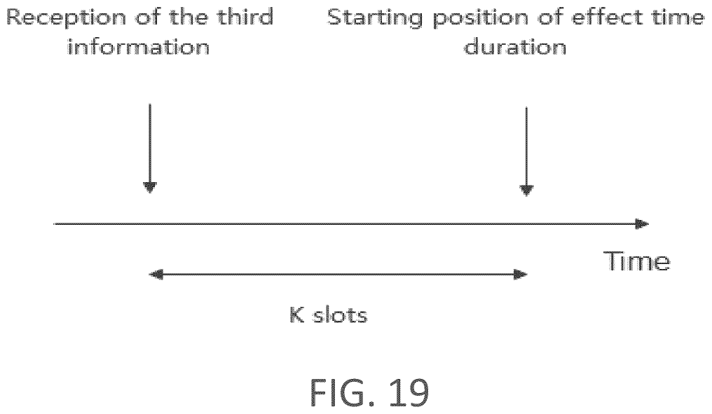

For example, as illustrated in FIG. 19, the starting position of the effect time duration is determined by the position of the third control signaling. The third control signaling comprises a value K for determining the starting position of the effect time duration is K slots after it has been received.

In some embodiment, the value K is configured by high layer parameter, e.g., RRC signaling, as an offset.

In some embodiments, a starting position of the effect time duration is a scheduled resource after the third control signaling.

In some embodiments, the third control signaling indicates the validity of one or more scheduled resource.

In some approaches, semi-persistent scheduling is used. The periodicity of semi-persistent scheduling transmission is small in order to transmit data for large and various packet size service with jitter impact (see FIG. 6).

In some embodiment, semi-persistent scheduling transmission is characterized by multiple transmission occasions in one duration (see FIG. 11).

In this case, a third control signaling is used to indicate the scheduled resource with data transmission. And the third control signaling indicates the validity of scheduled resource.

In some cases, the third control signaling is DCI. The valid scheduled resources mean there is data transmitting via the scheduled resource. The invalid scheduled resources mean there is no data transmitting in the scheduled resource. The periodicity of DCI transmission is the same as the periodicity of the semi-persistent scheduling transmission, or is the same as the periodicity of the scheduled resource in the effect time duration.

In some cases, the DCI is DCI format 2. DCI carries one bit to indicate the validity of scheduled resource. From gNB's perspective, bit ‘1’ indicates the scheduled resource is valid, and gNB transmits data in this scheduled resource, while bit ‘0’ indicates the scheduled resource is invalid, and gNB does not transmit data in this scheduled resource. While from UE's perspective, if DCI with value ‘1’ indication, UE detects and decodes the data in this scheduled resource, or if DCI with values ‘0’ indication, gNB skips the scheduled resource without detecting and decoding. In some cases, the DCI is DCI format 2_6 (see FIG. 12).

| Value | Description |
|---|---|
| ‘1’ | Valid scheduled resource |
| ‘0’ | Invalid scheduled resource |

In some cases, the DCI is DCI format 1. DCI carries one bit in one or more re-interpreted fields to indicate the validity of scheduled resource. The re-interpreted fields including:
Hybrid Automatic Repeat Request, HARQ, Process Number;
Redundancy version;
Time domain resource assignment;
Frequency domain resource assignment;
Modulation and coding scheme, MCS;
Downlink assignment index;
Transmit Power Control, TPC, command for scheduled Physical Uplink Control Channel, PUCCH;
and/or Virtual Resource Blocks to Physical Resource Blocks, VRB-to-PRB, mapping.

E.g., One bit of the field ‘Frequency domain resource assignment’ is re-interpreted for indicating the validity of scheduled resource.

In this case, the re-interpreted field is reused based on that a predefined condition is fulfilled. The predefined condition includes:
RRC signaling is configured (e.g., the RRC signaling is configured in SPS-config); and/or
One or more certain fields of DCI is set to all zeros or all ones.

The one or more certain fields of DCI includes:
HARQ Process Number;
Redundancy version;
Time domain resource assignment;
Frequency domain resource assignment;
MCS;
Downlink assignment index;
TPC command for scheduled PUCCH; and/or
VRB-to-PRB mapping.

E.g., when HARQ Process Number; Redundancy version; Time domain resource assignment are set to all zeros, the one bit in the re-interpreted filed for validity indication is available.

In some cases, the third signaling is reference signal. And reference signal indicates the validity of scheduled resource.

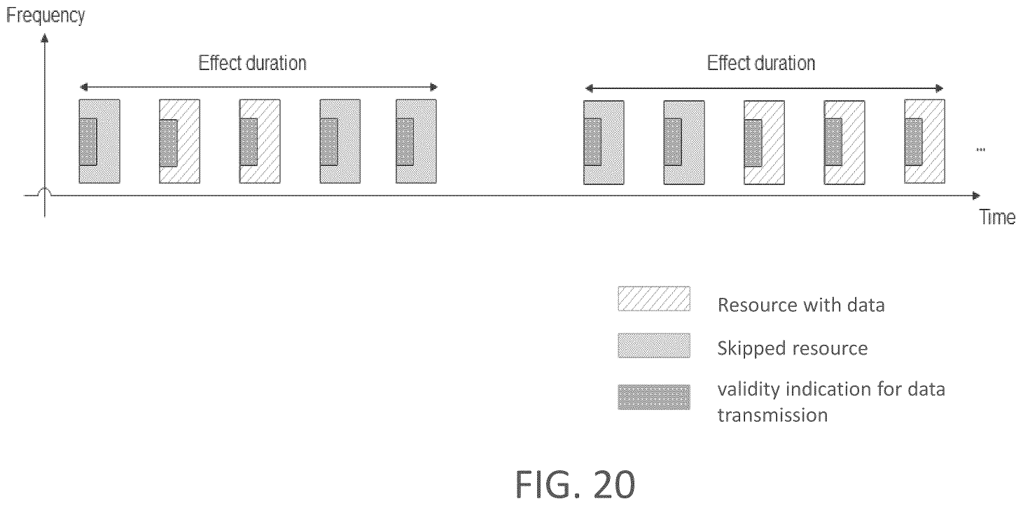

In some cases, the reference signal is DM-RS. The DM-RS transmits in every scheduled resources (see FIG. 20). From gNB's perspective, data and DM-RS is transmitted via the same scheduled resources while only DM-RS is transmitted via some scheduled resources. From UE's perspective, DM-RS detection is in every scheduled resources.

In this case, the DM-RS indicating a valid scheduled resource and the DM-RS an indicating invalid scheduled resource are orthogonal. The orthogonality is based on at least one of the following:
Sequence Initialization parameter: Re-defined n̅_{SCID}^{λ̅} and λ̅ are expressed as:

$${\overline{n}}_{SCID}^{\overline{λ}} = \{ \begin{matrix}{n}_{SCID} & λ = 1 \\ 1 - {n}_{SCID} & λ = 0 or λ = 2\end{matrix}$$

Valid scheduled resource indication DM-RS: λ=1
Invalid scheduled resource indication DM-RS: λ=0 or λ=2

### Scrambling Method

DM-RS mapping to physical resource can be express as:

$${\tilde{a}}_{k , l}^{( {\tilde{ρ}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , υ - 1$$

when transform precoding is not enabled; or

$${\tilde{a}}_{k , l}^{( {\tilde{ρ}}_{0} , μ )} = {w}_{f} ( {k}^{′} ) {w}_{t} ( {l}^{′} ) r ( 2 n + {k}^{′} )$$

$$k = 4 n + 2 {k}^{′} + Δ$$

$${k}^{′} = 0 , 1$$

$$l = \overline{l} + {l}^{′}$$

$$n = 0 , 1 , …$$

when transform precoding is enabled.
A. CDM group
   Valid scheduled resource indication DM-RS: CDM group=0
   Invalid scheduled resource indication DM-RS: CDM group=1
   or
   Valid scheduled resource indication DM-RS: CDM group=1
   Invalid scheduled resource indication DM-RS: CDM group=0
B. Frequency orthogonality
   Valid scheduled resource indication DM-RS: w_{f}^{(k′)}=+1 (k′=0)
   Invalid scheduled resource indication DM-RS: w_{f}^{(k′)}=−1 (k′=1)
   or
   Valid scheduled resource indication DM-RS: w_{f}^{(k′)}=−1 (k′=1)
   Invalid scheduled resource indication DM-RS: w_{f}^{(k′)}=+1 (k′=0)
C. Time orthogonality
   Valid scheduled resource indication DM-RS: wₜ^{(l′)}=+1 (I′=0)
   Invalid scheduled resource indication DM-RS: wₜ^{(l′)}=−1 (I′=1)
   or
   Valid scheduled resource indication DM-RS: wₜ^{(l′)}=−1 (I′=1)
   Invalid scheduled resource indication DM-RS: wₜ^{(l′)}=+1 (I′=0)
D. Transmission resource
   Valid scheduled resource indication DM-RS: Δ=0
   Invalid scheduled resource indication DM-RS: Δ=1
   or
   Valid scheduled resource indication DM-RS: Δ=1
   Invalid scheduled resource indication DM-RS: Δ=0

In some embodiments, the third control signaling indicates the location of one or more scheduled resources.

In this case, the third signaling is used to indicate the scheduled resource with data transmission. And the third signaling indicates the location of scheduled resource for data transmission. The location of scheduled resource for data transmission means the scheduled resource for data transmission is the first scheduled resource for data transmission or is the last scheduled resource for data transmission.

In some cases, the third signaling is DCI. In this case, from the gNB's perspective, if there is no data transmission in the scheduled resource in the effect duration, gNB does not transmit the DCI to UE and gNB does not transmit the data via corresponding scheduled resource. If data transmission starts, gNB transmits the DCI for UE to inform UE the corresponding scheduled resource is the starting scheduled resource for data transmission. And gNB transmits data in corresponding scheduled resource. If data transmission finishes, gNB transmits the DCI for UE to inform UE the corresponding scheduled resource is the ending scheduled resource for data transmission. After that, gNB does not transmit data in the scheduled resource in the effect duration. From the UE's perspective, if the DCI indicating the starting scheduled resource is not received, UE does not detect and decode the data in this scheduled resource and releases the resource. If the DCI indicating the starting scheduled resource is received, UE starts to detect and decode the data in the following scheduled resource until the DCI indicating the ending scheduled resource is received. If the DCI indicating the ending scheduled resource for data transmission is received, UE does not detect and decode the data in the scheduled resources behind the ending scheduled resource for data transmission and releases these scheduled resources in the effect duration.

Specifically, a DCI corresponds to a scheduled resource. In some cases, the scheduled resource is arranged after receiving or transmitting the DCI.

In some cases, the DCI is DCI format 2. In this case, SR carries one bit to carry the location of scheduled resource. From gNB's perspective, bit ‘0’ indicates the scheduled resource is the starting scheduled resource for data transmission, while bit ‘1’ indicates the scheduled resource is the ending scheduled resource for data transmission. While from UE's perspective, if DCI with value ‘0’ indication, UE detects and decodes the data in this scheduled resource, or if DCI with values ‘1’ indication, UE skips the scheduled resource without detecting and decoding (see FIG. 13). In some cases, the DCI is DCI format 2_6.

In some cases, the DCI is DCI format 1.

| Value | Description |
|---|---|
| ‘1’ | Starting scheduled resource for data transmission |
| ‘0’ | Ending scheduled resource for data transmission |

In some cases, the DCI indicates the starting scheduled resource for data transmission while MAC CE indicates the ending scheduled resource for data transmission by at least a number of scheduled resource associated with a counter. When starting scheduled resource is indicated, the counter starts to increase or decrease. If counter increases to the number of resource determined by MAC CE, or decrease to zero, gNB does not transmit data in the scheduled resource in the effect duration. And UE does not detect and decode the data in the scheduled resources behind the ending scheduled resource for data transmission and releases these scheduled resources in the effect duration (see FIG. 15).

In some cases, the indication includes starting scheduled resource for data transmission indication and ending scheduled resource for data transmission indication, or only the ending scheduled resource for data transmission indication.

In some embodiments, the reference signal determines the starting scheduled resource for data transmission and the ending scheduled resource for data transmission. The indication is carried by sequence initialization parameters; code division multiplexing (CDM) groups; scrambling in the frequency domain; scrambling in the time domain; or transmission resources. The reference signal comprises DM-RS, SRS, PT-RS, CSI-RS, RIM-RS. Many aspects of the reference signal determining the starting scheduled resource for data transmission and the ending scheduled resource for data transmission are similar to those of the reference signal indicating the scheduled resource is valid or invalid described above, and can be ascertained by referring to the embodiments above.

In some cases, the reference signal with the starting scheduled resource for data transmission indication transmits in every scheduled resources for data transmission except the last scheduled resource for data transmission. While reference signal with the ending scheduled resource for data transmission indication transmits in the last scheduled resource for data transmission. When UE detects the reference signal with the ending scheduled resource for data transmission indication, UE skips and the following scheduled resource in the effect time duration (see FIG. 15).

In some embodiments, the starting resource indication is not received, and one or more scheduled resources are skipped for data reception.

In some embodiments, the ending resource indication is received, and one or more scheduled resources are skipped for data reception.

In some embodiments, a scheduled resource is skipped for data reception means that the UE would not detect and decode data in this scheduled resource. For the gNB, the gNB would not transmit data in this scheduled resource.

Details of the information in the third control signaling can be ascertained by referring to the embodiment described above, and will not be described herein.

In some embodiments, the second control signaling or the third control signaling indicates supplement resources of the one or more scheduled resources for transmitting data. For example, one scheduled resource and a corresponding supplement resource transmit the data of the same packet. That is, the scheduled resource only transmits a part of data of the packet, and the remaining data of the packet is transmitted via the supplement resource.

In some embodiments, the second control signaling or the third control signaling indicates an effective part of the one or more scheduled resources transmitting the data. For example, the data is transmitted in some of the preconfigured resources (i.e., the effective part of the one or more scheduled resources transmitting the data) and not transmitted in the other preconfigured resources (the ineffective part of the one or more scheduled resources transmitting the data).

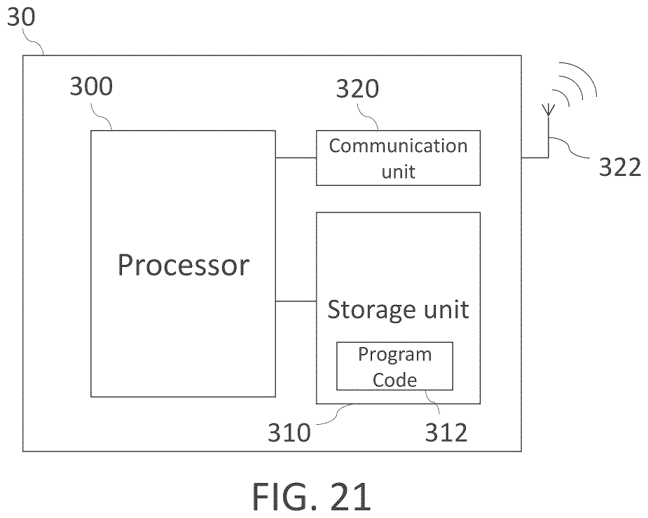

FIG. 21 relates to a schematic diagram of a wireless communication terminal 30 (e.g., a terminal node or a terminal device) according to an embodiment of the present disclosure. The wireless communication terminal 30 may be a user equipment (UE), a remote UE, a relay UE, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the remote UE or the relay UE described above. In some embodiments, the processor 300 and the communication unit 320 collaboratively perform the operations described above. For example, the processor 300 performs operations and transmit or receive signals, message, and/or information through the communication unit 320.

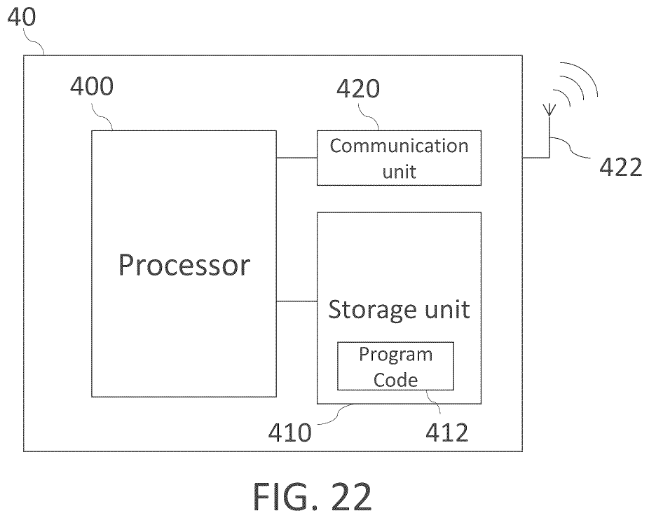

FIG. 22 relates to a schematic diagram of a wireless communication node 40 (e.g., a network device) according to an embodiment of the present disclosure. The wireless communication node 40 may be a satellite, a base station (BS), a gNB, a gNB-DU, a gNB-CU, a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

I/we claim:

1. A wireless communication method comprising:
receiving, by a wireless communication terminal from a wireless communication node, first control signaling;
determining, by the wireless communication terminal, one or more scheduled resources according to the first control signaling; and
performing, by the wireless communication terminal, a transmission of uplink data or a reception of downlink data based on the one or more scheduled resources.

2. The wireless communication method of claim 1, wherein at least one of the following:
the transmission of the uplink data is based on second control signaling; or
the one or more scheduled resources include one or more time occasions for at least one of uplink transmission or downlink transmission.

3. The wireless communication method of claim 1, wherein at least one of the following:
the reception of the downlink data is based on third control signaling; or
the first control signaling comprises one or more effect time durations for an indication conveyed by second control signaling or third control signaling.

4. The wireless communication method of claim 2, wherein the second control signaling is at least one of: Radio Resource Control, RRC, signaling; Medium Access Control Control Element, MAC CE; Uplink Control Information, UCI, or a reference signal.

5. The wireless communication method of claim 2, wherein the second control signaling indicates at least one of: an effect time duration; one or more valid or invalid indications of the one or more scheduled resources, wherein a bit indicates validity or invalidity of a scheduled resource of the one or more scheduled resources, one or more locations of the one or more scheduled resources for data transmission; a buffer size indication; a priority indication; delta modulation and coding scheme; a time domain resource assignment; or a frequency domain resource assignment.

6. The wireless communication method of claim 5, wherein the effect time duration indicated by the second control signaling is one of one or more effect time duration comprised in the first control signaling.

7. The wireless communication method of claim 5, wherein at least one of the following:
a starting position of the effect time duration is determined by at least one of the position of the second control signaling or an offset; or
a starting position of the effect time duration is a scheduled resource after the second control signaling.

8. The wireless communication method of claim 5, wherein the one or more scheduled resources with invalid indications are skipped for data transmission.

9. A wireless communication method comprising:
transmitting, by a wireless communication node to a wireless communication terminal, a first control signaling, wherein the first signaling indicates one or more scheduled resources; and
performing, by the wireless communication node, a reception of uplink data based on the one or more scheduled resources.

10. The wireless communication method of claim 9, wherein at least one of the following:
the reception of the uplink data is based on second control signaling; or
the one or more scheduled resources include one or more time occasions for at least one of uplink transmission or downlink transmission.

11. The wireless communication method of claim 9, wherein at least one of the following:
the reception of downlink data is based on third control signaling; or
the first control signaling comprises one or more effect time durations for an indication conveyed by second control signaling or third control signaling.

12. The wireless communication method of claim 10, wherein the second control signaling is at least one of: Radio Resource Control, RRC, signaling; Medium Access Control Control Element, MAC CE; Uplink Control Information, UCI, or a reference signal.

13. The wireless communication method of claim 10, wherein the second control signaling indicates at least one of: an effect time duration; one or more valid or invalid indications of the one or more scheduled resources, wherein a bit indicates validity or invalidity of a scheduled resource of the one or more scheduled resources, one or more locations of the one or more scheduled resources for data transmission; a buffer size indication; a priority indication; delta modulation and coding scheme; a time domain resource assignment; or a frequency domain resource assignment.

14. The wireless communication method of claim 13, wherein the effect time duration indicated by the second control signaling is one of one or more effect time duration comprised in the first control signaling.

15. The wireless communication method of claim 13, wherein at least one of the following:
a starting position of the effect time duration is determined by at least one of the position of the second control signaling or an offset; or
a starting position of the effect time duration is a scheduled resource after the second control signaling.

16. The wireless communication method of claim 13, wherein the one or more scheduled resources with invalid indications are skipped for data reception.

17. The wireless communication method of claim 5, wherein at least one of the following:
the buffer size indication indicates a request size of data in the one or more scheduled resources;
a length of buffer size indication is associated with a logical channel group indication;
the logical channel group indication is determined by at least one of MAC CE or UCI; or
the priority indication indicates a priority of the one or more scheduled resources to allow data transmission via the scheduled resources when a collision occurs.

18. The wireless communication method of claim 3, wherein at least one of the following:
the third control signaling is at least one of: Radio Resource Control, RRC, signaling; Medium Access Control Control Element, MAC CE; Downlink Control Information, DCI, or a reference signal;
the DCI comprises at least one block set, the block set comprises one or more blocks, each block is associated with at least one of: one or more configurations, one or more configuration sets, one or more user equipments, one or more serving cells, or one or more serving cell groups;
the configuration set comprises one or more configurations, and the configurations comprises one or more scheduled resources;
location information of the blocks in the DCI is determined by at least one of: one or more high layer parameters or one or more bit widths of one or more information fields;
the DCI comprises at least one of the following re-interpreted information fields to determine configurations: Hybrid Automatic Repeat Request, HARQ, Process Number; Redundancy version; Time domain resource assignment; Frequency domain resource assignment; Modulation and coding scheme, MCS; Downlink assignment index; Transmit Power Control, TPC, command for scheduled Physical Uplink Control Channel, PUCCH; or Virtual Resource Blocks to Physical Resource Blocks, VRB-to-PRB, mapping;
the at least one of the information fields of the DCI is re-interpreted in response to at least one of: one or more high layer parameters; or at least one of the following information fields being set to a predefined value: HARQ Process Number; Redundancy version; Time domain resource assignment; Frequency domain resource assignment; MCS; Downlink assignment index; TPC command for scheduled PUCCH; or VRB-to-PRB mapping;
the reference signal comprises at least one of a demodulation reference signal, DM-RS; a sounding reference signal, SRS; a phase track reference signal, PT-RS; a CSI reference signal, CSI-RS; or a remote interference management reference signal, RIM-RS;
the reference signal for different indications are orthogonal through at least one of: sequence initialization parameters; code division multiplexing, CDM, groups; scrambling in frequency domain; scrambling in time domain; or transmission resources; or
the third control signaling comprises at least one of: an effect time duration; one or more valid or invalid indications of the one or more scheduled resources, one or more locations of the one or more scheduled resources for data reception; or an interval between the third control signaling and the one or more scheduled resources.

19. The wireless communication method of claim 13, wherein at least one of the following:
the buffer size indication indicates a request size of data in the one or more scheduled resources;
a length of buffer size indication is associated with a logical channel group indication;
the logical channel group indication is determined by at least one of MAC CE or UCI; or
the priority indication indicates a priority of the one or more scheduled resources to allow data transmission via the scheduled resources when a collision occurs.

20. The wireless communication method of claim 11, wherein at least one of the following:
the third control signaling is at least one of: Radio Resource Control, RRC, signaling; Medium Access Control Control Element, MAC CE; Downlink Control Information, DCI, or a reference signal;
the DCI comprises at least one block set, the block set comprises one or more blocks, each block is associated with at least one of: one or more configurations, one or more configuration sets, one or more user equipments, one or more serving cells, or one or more serving cell groups;
the configuration set comprises one or more configurations, and the configurations comprises one or more scheduled resources;
location information of the blocks in the DCI is determined by at least one of: one or more high layer parameters or one or more bit widths of one or more information fields;
the DCI comprises at least one of the following re-interpreted information fields to determine configurations: Hybrid Automatic Repeat Request, HARQ, Process Number; Redundancy version; Time domain resource assignment; Frequency domain resource assignment; Modulation and coding scheme, MCS; Downlink assignment index; Transmit Power Control, TPC, command for scheduled Physical Uplink Control Channel, PUCCH; or Virtual Resource Blocks to Physical Resource Blocks, VRB-to-PRB, mapping;
the at least one of the information fields of the DCI is re-interpreted in response to at least one of: one or more high layer parameters; or at least one of the following information fields being set to a predefined value: HARQ Process Number; Redundancy version; Time domain resource assignment; Frequency domain resource assignment; MCS; Downlink assignment index; TCP command for scheduled PUCCH; or VRB-to-PRB mapping;
the reference signal comprises at least one of a demodulation reference signal, DM-RS; a sounding reference signal, SRS; a phase track reference signal, PT-RS; a CSI reference signal, CSI-RS; or a remote interference management reference signal, RIM-RS;
the reference signal for different indications are orthogonal through at least one of: sequence initialization parameters; code division multiplexing, CDM, groups; scrambling in frequency domain; scrambling in time domain; or transmission resources; or
the third control signaling comprises at least one of: an effect time duration; one or more valid or invalid indications of the one or more scheduled resources, one or more locations of the one or more scheduled resources for data reception; or an interval between the third control signaling and the one or more scheduled resources.
